(19) United States
(12) Patent Application Publication
(10) Pub. No.: US 2006/0085818 A1
(43) Pub. Date: Apr. 20, 2006

(54) Introducing new content items in a community-based recommendation system

(76) Inventors: Maarten Peter Bodlaender, EINDHOVEN (NL); Gerrit Hollemans, Eindhoven (NL); Fabio Vignoli, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/534,481

(22) PCT Filed: Oct. 27, 2003
(86) PCT No.: PCT/IB03/04768

§ 371 Date: May 10, 2005

(30) Foreign Application Priority Data
Nov. 15, 2002 (EP) 02079769.2

(51) Int. Cl. H04N 7/025; H04N 7/10; G06F 13/00; H04N 5/445

(52) U.S. Cl. 725/46; 725/34; 725/35

(57) ABSTRACT

The invention relates to a method of operating with content items, generating of a user preference profile, and introducing new content items in a community-based recommendation system. A virtual user terminal (115) determines a new user preference profile when detecting the availability of a new content item. The virtual user terminal (115) comprises an initialization processor (123) which sets a preference value in the user preference profile for the new content item. The virtual user terminal (115) further comprises a relation processor (125) which determines related content items, and a profile processor (127), which sets preference values in the user preference profile associated with the at least one related content item. Hence, an association is formed between the first content item and the related content items, thereby linking the new content item to existing content items, and thus increasing the probability that the new content item is recommended.

The invention relates to a method and apparatus for operating with content items in a community-based recommendation system.

In recent years, the accessibility to and provision of information and content such as TV programs, film, music and books, etc. have increased explosively. Especially, the advent of the Internet as an increasingly available source of information has resulted in the main problem that faces most users, namely not whether appropriate information or content is available but how this can be found. Specifically, it has become increasingly important that the services and content provided to a user are targeted to this user and thus meet his specific user profile and reflect his personal preferences.

One method of customizing e.g. the information and content provision to a specific user is a recommendation-based approach, wherein specific content or information is determined to be suited for a user and therefore recommended to him. One recommendation approach is a community-based recommendation approach, wherein feedback and preferences received from a suitable community are used to determine recommendations for a user in that community. Thus, for example, certain behaviors or actions are observed and categorized for a community, and if another user exhibits a similar behavior, the information or content accessed by users in that category may be recommended.

An example of a community-based recommendation system is known from several e-commerce Internet sites, wherein the purchasing behavior of users is monitored. A user having a purchasing behavior similar to a stored behavior is recommended purchases similar or identical to purchases made by other users in that group. A well-known example is when a purchaser of a book is recommended a number of other books that have been purchased by other users also purchasing the current book.

Typically, community-based recommendation systems operate by comparing user profiles of different users and recommending users content that other users having similar profiles have preferred. However, typically, users will therefore only or predominantly be recommended content that has already been evaluated by other users. Typically, for community-based recommendation systems, the recommendations made tend to be of content with the highest prevalence in user profiles. Therefore, the more user profiles comprise a given content, the more likely it is to be recommended to another user. The more a content item is recommended, the more likely it is to be included in a user profile, and as the probability of a content item being recommended increases with increased dissemination, a community-based recommendation system typically has a tendency towards providing undesirably narrow recommendations of mainly the most popular content items. The recommendations may further become increasingly narrow over time and thus do not provide a desired flexibility and diversity in the recommendations. Specifically, it tends to be difficult for a new content item to be introduced to a community-based recommendation system without an undesirable latency.

Also, as typical community-based recommendation systems tend to be based on a number of user profiles, it may be difficult to impact the recommendations performed by the community-based recommendation system. Furthermore, in most community-based recommendation systems, no other way of affecting the recommendations than through user profiles is possible. For example, in a centrally operated community-based recommendation system, wherein the recommendations are made by a central recommender, only the operator of the recommender can affect the recommendations, except through user profiles.

Hence, an improved community-based recommendation would be advantageous and in particular community-based recommendations allowing an increased flexibility, diversity and/or means for influencing the recommendations would be advantageous.

Accordingly, the invention seeks to provide means allowing improved community-based recommendations. Preferably, the invention tends to improve the performance of a community-based recommendation system and/or to allow an increased flexibility, diversity and/or means for influencing the recommendations.

According to a first aspect of the invention, a method of operating with content items in a community-based recommendation system comprises the steps of: initializing a first element of a user preference profile with a first preference value, the first element being associated with a first content item; determining at least one related content item related to the first content item; setting a second preference value of an element of the user preference profile associated with the at least one related content item.

The invention enables recommendations to be made in response to the preferences determined in the user preference profile, and specifically in response to the association made by the user preference profile between the first content item and the at least one related content item. Specifically, the first and second preference values may be set to cause a recommender to associate the first content item with the at least one related content item. Hence, the user preference profile may preferably be included in a community-based recommendation system, thereby resulting in associations being formed between the first content item and the at least one related content item. This may specifically cause the first content item to be recommended to users having high preference values for the at least one related content item. For example, a new first content item may thus be introduced to a community-based recommendation system by a user preference profile wherein both the user preference for a new content item as well as preference values for existing content items are set to cause an association between these. Hence, the user preference profile may introduce the first content item to the community and may specifically target a specific group of the community by an appropriate setting of the preference values for related content items. This allows a targeted and directed introduction of new content items.

The user preference profile may specifically be compatible with a given community-based recommendation system. The user preference profile may thus allow the recommendations of a community-based recommendation system to be influenced. The method provides a very flexible recommendation system. It further provides an efficient and easy way to implement means for increasing the diversity and variation of recommendations. Specifically, it allows new content to be introduced to a community-based recommendation system, and this to be recommended. Specifically, the user preference profile may allow an association to be made between a new first content item and content item already included in the recommendation system. The user preference profile may specifically be generated as an update or modification to an existing user preference profile.

According to a feature of the invention, the second preference value is similar to the first preference value. Hence, the preference value of the related content item may be similar to that of the first content item. Specifically, an association of the first content item with the at least one related content item is achieved by setting the preference value for these content items to be similar, for example by setting them to be equivalent or substantially identical. This provides a suitable means for association, which is compatible with most community-based recommendation systems. Hence, related contents are preferably set to have similar preference values.

According to another feature of the invention, the first preference value is a high preference value. This allows a high preference value to be set for the first content item, thereby causing a high probability of the first content item being recommended to other users of the community-based recommendation system. Specifically, by setting the second preference value high in the user preference profile, a great probability of recommendation of the first content item to users having a high preference for the at least one related content item is achieved.

According to another feature of the invention, an equivalence of the first preference value and the second preference value is determined in response to a degree of similarity between the first content item and the at least one related content item. Specifically, the equivalence between the first and second preference values may be increased for increasing similarity between the first content item and the at least one related content item. This allows a further refinement in influencing recommendations.

According to another feature of the invention, the method further comprises the steps of determining if the first content item is a new content item, wherein the steps of initializing, determining and setting are only performed if the first content item is new. The method may specifically consider a plurality of content items and for each of these determine if the content item is a new content item. The generation of a user preference profile may only be performed for new content items. For example, the method may be comprised in a functional entity which monitors a plurality of content items and detects which are new. For these new content items, a new virtual user preference profile may be generated that provides a suitable association between the new content item and existing content items to be generated. A new content item may be, for example, a content item that has not previously been rated, is not included in a list of content items, is received from a specific source or meets a set of predetermined criteria and/or characteristics. This provides a system wherein suitable content items are automatically associated with existing content items to ensure an increased probability of recommendation.

According to another feature of the invention, the information of an availability of the content item is received from a source which is not part of the community-based recommendation system. The information may be received, for example, by a dedicated information message provided by an external source. The information may thus be provided independently of the operation of the community-based recommendation system. This allows a content item to be introduced to the community-based recommendation system without any need for involving an operator or central controller of the community-based recommendation system. Additionally or alternatively, the external source may be an existing source and could comprise, for example, news information sources, and in particular news information sources specifically aimed at the typical users of the community-based recommendation system and/or related to one or more categories of content items of the community-based recommendation system.

According to another feature of the invention, the at least one related content item is determined from a category to which the first content item belongs. Preferably, the category is determined from a correspondence of at least one of the following: an artist; a content item type; and a music style. This ensures a suitable and reliable approach to determining a related content item. For example, a given content item belonging to a specific category, such as a musical number of a specific music style, and by a specific artist, may lead to all other musical numbers of that artist in that music style being identified and determined as related content. The preference value of all of these content items may accordingly be set to have a suitable preference value in the user preference profile, wherein an association is formed to the first content item. This may lead to the first content item being recommended to users that have high preference values for one or more of the other musical numbers of that artist and/or that music style.

According to another feature of the invention, the method further comprises the step of setting the first preference value in response to a predetermined preference value profile. Preferably, the predetermined preference value is determined in response to a characteristic feature of the first content item. For example, a high preference value may be set for content items being associated with a first category and/or artist. This may cause all content items of that category and/or artist to be increasingly recommended. If the first content item is determined to relate to a different category and/or artist, the rating may be, for example, lower so that the probability of recommendation is reduced but is still present. It thus allows a further graduation of the probability of recommendation of content item and/or an automatic establishment of a user preference profile having the desired characteristics and impact on recommendations.

According to another feature of the invention, the step of setting the first preference value comprises determining a category of the first content item and setting the first preference value to the predetermined preference value profile for the category. This provides a suitable approach to setting the first preference value to a desired value.

According to another feature of the invention, the method further comprises the steps of: initializing an element of a second user preference profile with a preference value, the element being associated with the first content item; determining at least one related content item related to the first content item; and setting a further preference value of an element of the second user preference profile associated with the at least one related content item.

Preferably, two or more user preference profiles are generated in response to receiving information of the availability of the first content item. The two or more different user preference profiles may specifically have different preference values related to the first content item and/or at least one related content item. Furthermore, the second user preference profile may set preference values of other related content items than the ones set for the first user preference profile. Two or more user preference profiles allow targeting of separate and various groups.

According to a second aspect of the invention, an apparatus for operating with content items in a community-based recommendation system comprises: a receiver for receiving information of an availability of a first content item; an initialization processor for initializing a first element of a user preference profile with a first preference value, the first element being associated with the first content item; a relation processor determining at least one related content item related to the first content item; and a profile processor for setting a second preference value of an element of the user preference profile associated with the at least one related content item.

These and other aspects of the invention are apparent from and will be elucidated with reference to the embodiment(s) described hereinafter.

An embodiment of the invention will be described, by way of example only, with reference to the drawings, in which

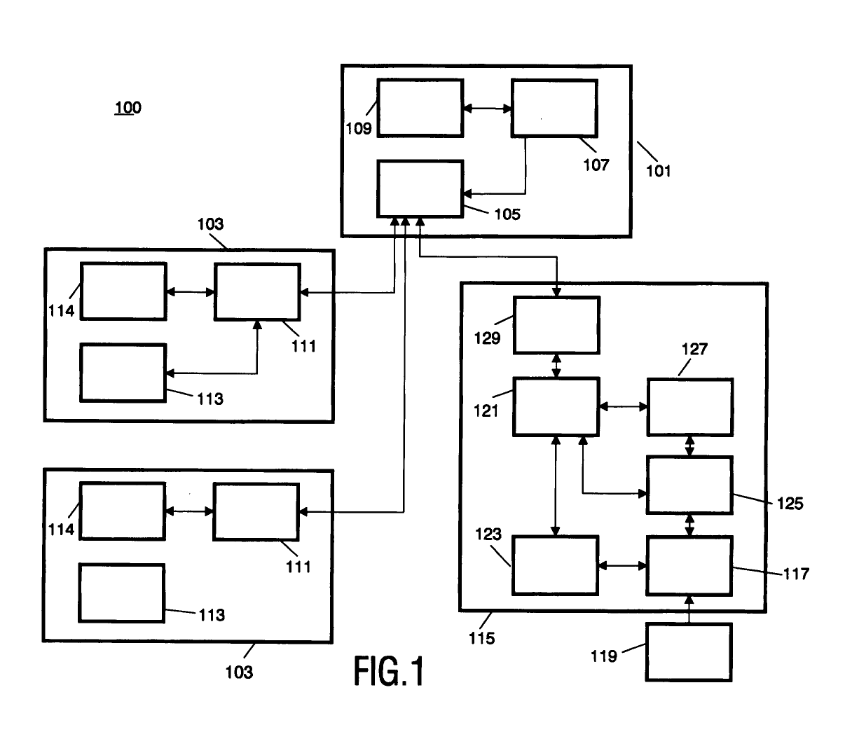

FIG. 1 is an illustration of a community-based recommendation system comprising an apparatus for operating with content items in accordance with an embodiment of the invention; and

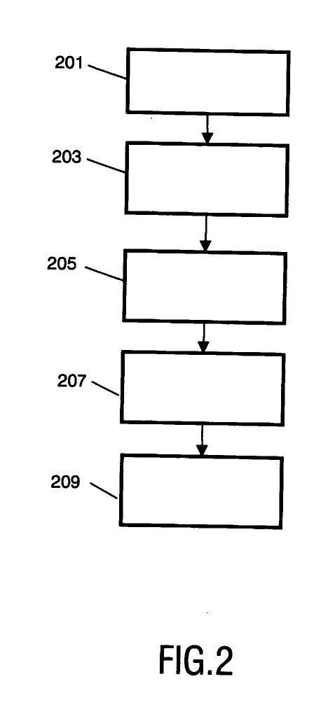

FIG. 2 is an illustration of a method of operating with content items in accordance with an embodiment of the invention.

The following description focuses on an embodiment of the invention in a centrally based community-based recommendation system. However, it will be apparent that the invention is not limited to this application but may be applied to many recommendation systems including non-centrally based community-based recommendation systems. In the described example, individual user preference profiles are generated and maintained in individual user terminals but it will be apparent that user preference profiles may be generated in any suitable way and at any suitable physical, architectural or logical location.

FIG. 1 is an illustration of a community-based recommendation system comprising an apparatus for operating with content items in accordance with an embodiment of the invention.

The community-based recommendation system 100 has a central recommendation controller 101 and a plurality of user terminals 103 (two shown). In the described embodiment, the central recommendation controller 101 may specifically be a website on the Internet providing music recommendations to a community. In this example, the central recommendation controller 101 only provides recommendations. In response to a recommendation the user of a user terminal may access a suitable website for downloading the recommended song. Specifically, the central recommendation controller 101 may include the IP address from which the recommended song may be downloaded. Typically, the IP address will be that of a record label website from which the song can be downloaded for a given charge.

The central recommendation controller 101 comprises a recommender communication element 105 for receiving and transmitting data. Specifically, the recommender communication element 105 receives user preference profiles from the user terminals 103 and transmits recommendations generated in response to the user terminals 103. The recommender communication element 105 is connected to a recommender 107. The recommender is further connected to a user preference profile database 109. The user preference profile database 109 comprises information related to user preference profiles of the community. Hence, when a user preference profile is fed to the recommender 107, the recommender updates the user preference profile database 109 in response to the received user preference profile. In a simple embodiment, each user preference profile is stored unaltered in the user preference profile database 109. In more advanced embodiments, the information of the user preference profiles may be processed to generate more complex and suitable user preference information. For example, preferences of a plurality of users may be combined, averaged or grouped together to provide additional and improved information.

When the recommender communication element 105 receives a user preference profile from a user terminal 103, it is fed to the recommender. It is then added to the user preference profile database 109 if it is not already comprised therein. If a version of the user preference profile already exists in the user preference profile database 109, this may be replaced or updated by the new user preference profile. In addition, the recommender searches the user preference profile database 109 to identify a user preference profile similar to the one received. If one is identified, the content items of the equivalent user preference profile having a high preference value are generated as recommendations. The recommendations are fed to the recommender communication element 105 for transmission to the user terminals 103.

A user terminal 103 comprises a user terminal communication element 111 for transmitting user preference profiles to and receiving recommendations from the recommender 105. The user terminal communication element 111 is connected to a user interface 113 for presentation to the user. The user interface 113 may specifically comprise a display such as a computer monitor. In addition, the user terminals 103 in the described embodiment comprise a user preference profile memory 114, wherein a user preference profile for the user is generated in response to the usage of the user terminal. The user preference profile may thus typically comprise a list of various content items and a user rating of these. Thus, the user preference profile comprises information of the user's preference for one or more content items.

The user preference profile may be communicated to the recommender 105 at any suitable time. For example, the user preference profile may be communicated at power up of the user terminal 103, when the user preference profile is modified, when the user performs a special action, such as playing a content item, or when the user of the user terminal 103 specifically requests a recommendation.

In addition to the user terminals, the community-based recommendation system 100 further comprises a virtual user terminal 115. The virtual user terminal 115 comprises a receiver 117 for receiving information of an availability of a first content item. Specifically, the receiver 117 may receive information of the availability of the first content item from an external source 119. In one embodiment, the external source specifically provides information of content item availability to the virtual user terminal 115, whereas in other embodiments, the virtual user terminal 115 derives the information from analysis of information retrieved from the external source. In the specific example, the external source may be an information source operated by a record label to provide information of new songs being issued. Alternatively or additionally, the external source may be a music Internet site accessed by the virtual user terminal 115 and scanned for information of new songs that have been issued.

The virtual user terminal 115 further comprises a user preference profile memory 121, wherein a user preference profile may be stored. Additionally, the virtual user terminal 115 comprises an initialization processor 123 for initializing a first element of a user preference profile with a first preference value. The first element is associated with the first content item. The initialization processor 123 is connected to the receiver 117 and the user preference profile memory 121.

When the receiver 123 receives information of the availability of a new content item, it is fed to the initialization processor 123. In response, the initialization processor 123 accesses the user preference profile memory 121 to set a suitable preference value for the new content item. Specifically, the initialization processor 123 creates an entry for the new content item and assigns it a high preference value.

The virtual user terminal 115 further comprises a relation processor 125 determining at least one related content item related to the first content item. The relation processor 125 is connected to the receiver 117 and when the availability of a new content item is identified, the relation processor 125 searches through the user preference profile to identify related content items.

Hence, in the preferred embodiment, the user preference profile comprises information of a plurality of content items. This information may be derived from previous content items identified through the external source, downloaded from the recommender 105, determined from monitoring traffic of the community-based recommendation system or in any other suitable way. In other embodiments, a new user preference profile may be generated for each new content item. In this case, one or more related content items may be determined in any suitable way. For example, a user preference profile may be downloaded from the recommender or another user terminal, a database of content items (e.g. a music website) may be accessed to identify content item or content items may be received from the external source together with the information of the availability of a new content item.

In the preferred embodiment, content items are associated with one or more different categories. For example, a content item category may be a type of the content item, such as, for example, a video clip or program, an audio clip or program, a text-based content item, a piece of software or a multimedia clip, etc. A category may further relate to the content of the content items, such as, for example, an artist or music style associated with the content item. For example, a new content item which is a song may be associated with a category of a song, of the artist, of the music style, of the length of the song, of a country of origin, etc.

In the preferred embodiment, a related content item is determined in response to the association of categories. Particularly, a related content item is determined from being in at least one category to which the first content item belongs. The category may specifically be a combined category such as the category of the specific artist and music style. Hence, in the preferred embodiment, the relation processor scans the user preference profile to identify all content items that have at least one category in common with the new content item.

The virtual user terminal 115 further comprises a profile processor 127 for setting a second preference value of an element of the user preference profile associated with the at least one related content item. The profile processor 127 is connected to the relation processor 125 and the user preference profile memory 121.

In the preferred embodiment, the profile processor 127 sets a preference value in the user preference profile for all of the related content items identified by the relation processor 127. In a simple embodiment, the profile processor 127 simply sets a high preference values for all related content items. In this embodiment, when the availability of a new content item is detected, the preference values are set as high as possible, not only for the new content item itself but also for other content items which are found to have a close correspondence with the new content item. Hence, a strong association is established between the new content item and existing similar content items. Consequently, the use of this user preference profile in the central recommendation controller 101 is likely to cause the new content item to be recommended to users having a high preference for the related content items. Hence, by not only setting a preference value for the new content item but also for related existing content items, the new content item is linked to existing content items and thereby introduced to the community-based recommendation system.

In more advanced embodiments, the preference values of the related content items are similar to those of the first content item. Hence, if the first content item is given a high preference value, so are the related content items. In other embodiments, the equivalence between the preference values of the new content item and the related content items depend on a degree of similarity between the content items. Specifically, the closer the correspondence between the new content item and the related content items, the higher the correlation between the assigned preference values of the new content item and the related content items.

For example, in one embodiment, each content item may be associated with a plurality of categories. A related content item having the same associated categories as the new content item is set to have the same preference value in the user preference profile as the new content item. Specifically, this may be a high preference value. A related content item having fewer categories in common with the new content item is given a lower preference value. Specifically, the preference value decreases for decreasing numbers of categories in common. A flexible setting of preference values for the related content item thus provides a further graduation in the association between the new content item and related content items.

The virtual user terminal 115 comprises a communication element 129 connected to the user preference profile memory 121. The communication element 129 is operable to transmit the user preference profile of the virtual user terminal 115 to the central recommendation controller 101. The communication element 129 may further be operable to receive information related to the user preference profile database 109 for use in determining related content items.

Thus, in a preferred embodiment, the virtual user terminal 115 is operable to generate a user preference profile for a community-based recommendation system. FIG. 2 is an illustration of a method of operating with content items in accordance with an embodiment of the invention. The method is applicable to the virtual user terminal 115 of FIG. 1.

In step 201, the receiver 117 receives information of an availability of a first content item. In step 203, the initialization processor 123 initializes a first element of a user preference profile with a first preference value, the first element being associated with the first content item. In step 205, the relation processor determines at least one related content item related to the first content item. In step 207 the profile processor 127 sets a second preference value of an element of the user preference profile associated with the at least one related content item. In step 209, the communication element 129 transmits the user preference profile to the central recommendation controller 101.

In the preferred embodiment, the virtual user terminal 115 further determines if the first content item is a new content item. The steps of initializing, determining and setting the preference values in the user preference profile are only performed if the first content item is determined to be new. Any suitable algorithm and criterion for determining a content item to be new may be used. Specifically, a content item may be determined to be new if it has not already been rated and specifically if it is not comprised in the user preference profile database 109. In the preferred embodiment, a user preference profile is thus only generated for new content items.

In the preferred embodiment, the preference value of the new content item is set in response to a predetermined preference value profile, and the preference value is preferably further determined in response to a characteristic of the first content item. In this embodiment, a predetermined preference value profile is generated comprising preference values set for a plurality of different categories of content items. For example, a first preference value may be assigned to content items associated with a first artist, a second preference value to content items associated with a second artist, and so on. When a new content item is identified, it is determined in which category the new content item belongs, and the associated preference value is assigned. This provides a graduation of the preference values assigned, and thus allows that the initial strength of the preference (and thus the probability of recommendation) may be controlled in accordance with a specific profile. As a specific example, a record label may have a predetermined preference value profile wherein all content items from that record label have a very high preference value, and all content items from other record labels have a low or neutral preference value. This will allow the record label to automatically bias recommendations towards new content items from the record label.

The preferred embodiment thus ensures that by not only setting a preference value of the new content item but also of related content item(s), an association is created to other content items, and thus the new content item is linked to the existing recommendation system. Furthermore, as the related content items and/or preference values can be selected to have a desired effect on the recommendations, the new content item can be aimed at a suitable target group. Specifically, a new content item need not be recommended in general to a large group of users but can be specifically recommended to a small group of users having a high preference for similar content items. This ensures a targeted introduction of new content in a community-based recommendation system.

It will be apparent that the user preference profile need not be generated in the individual user terminals. For example, in other embodiments, all user preference profiles are generated and stored in a central recommendation unit. The user preference profile of a user may in this example be generated from the behavior of a user such as, for example, the selections of content items made by a user. It will further be apparent that the recommendation function need not be implemented centrally but may be, for example, performed in individual user terminals in response to received user preference profile information relating to other users.

Although the above description has focused on generating of one specific user preference profile, a plurality of different user preference profiles may be generated in response to detecting that a new content item is available. Effectively, the process described above may be iterated for different user preference profiles using modified criteria.

As a specific example, a new content item may be a poem converted into a popular song. In this case, a first user preference profile may be generated, which aimes at a group of users interested in popular songs and music but perhaps not poetry. A second user preference profile may be generated for a group of users having a high preference for poetry but a low preference value for popular music. In this way, the new content item is linked to both user groups. Hence, generation of multiple user preference profiles allows targeting of a plurality of various groups, which may overlap only in the specific area of the new content item.

The invention can be implemented in any suitable form including hardware, software, firmware or any combination of these. However, the invention is preferably implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, use of the verb “comprise” and its conjugations does not exclude the presence of other elements or steps. Furthermore, although individually stated, a plurality of means, elements or method steps may be implemented by e.g. a single unit or processor. Moreover, although individual features may be included in different claims, these may possibly be advantageously combined, and the inclusion in different claims does not imply that a combination of features is not feasible and/or advantageous. In addition, singular references do not exclude a plurality. Thus references to “a”, “an”, “first”, “second” etc do not preclude a plurality.

1. A method of operating with content items in a community-based recommendation system; the method comprising the steps of:
initializing (203) a first element of a user preference profile with a first preference value, the first element being associated with a first content item;
determining (205) at least one related content item related to the first content item; and
setting (207) a second preference value of an element of the user preference profile, associated with the at least one related content item.

2. A method as claimed in claim 1, further comprising a step of receiving information (201) of an availability of the first content item.

3. A method as claimed in claim 1, wherein the second preference value is similar to the first preference value.

4. A method as claimed in claim 1, wherein the first preference value is a high preference value.

5. A method as claimed in claim 1, wherein an equivalence of the first preference value and the second preference value is determined in response to a degree of similarity between the first content item and the at least one related content item.

6. A method as claimed in claim 1, further including the steps of determining if the first content item is a new content item and wherein the steps of initializing, determining and setting are only performed if the first content item is new.

7. A method as claimed in claim 2 wherein the information of an availability of the content item is received from a source which is not part of the community-based recommendation system.

8. A method as claimed in claim 1, wherein the at least one related content item is determined from a category to which the first content item belongs.

9. A method as claimed in claim 8, wherein the category is determined from a correspondence of at least one of the following:
a. an artist;
b. a content item type; and
c. a music style.

10. A method as claimed in claim 1, further comprising the step of setting the first preference value in response to a predetermined preference value profile.

11. A method as claimed in claim 10, wherein the first preference value determined in response to the predetermined preference value profile is determined in response to a characteristic of the first content item.

12. A method as claimed in claim 10, wherein the step of initializing (203) a first element of the user preference profile with the first preference value comprises determining a category of the first content item and setting the first preference value to the predetermined preference value profile for the category.

13. A method as claimed in claim 1, further comprising the steps of:
initializing an element of a second user preference profile with a preference value, the element being associated with the first content item;
determining at least one related content item related to the first content item; and
setting a further preference value of an element of the second user preference profile associated with the at least one related content item.

14. A computer program enabling a method to be carried out according to claim 1.

15. A record carrier comprising a computer program as claimed in claim 14.

16. An apparatus for operating with content items in a community-based recommendation system; the apparatus comprising:
a receiver (117) for receiving information of an availability of a first content item;
an initialization processor (123) for initializing a first element of a user preference profile with a first preference value, the first element being associated with the first content item;
a relation processor (125) determining at least one related content item related to the first content item; and
a profile processor (127) for setting a second preference value of an element of the user preference profile associated with the at least one related content item.

17. A community-based recommendation system comprising an apparatus as claimed in claim 16.
